(19) United States
(12) Patent Application Publication
(10) Pub. No.: US 2026/0170760 A1
(43) Pub. Date: Jun. 18, 2026

(54) CREATION OF THREE DIMENSIONAL (3D) ITEM-WAREHOUSE MAP USING DATA OF VARIOUS GRANULARITIES

(71) Applicant: Maplebear Inc., San Francisco, CA (US)

(72) Inventors: Wentao Pan, Shanghai (CN); Ruoruo Zhang, Santa Clara, CA (US); David McIntosh, San Francisco, CA (US); Lauren Jean Herr, Swedesboro, NJ (US); Tim Petrvalsky, Pearland, TX (US); Nicholas Sturm, Denver, CO (US); Amy Vaduthalakuzhy, San Francisco, CA (US); Graham Beauregard, Burlington (CA); Kevin Shepherd, Austin, TX (US); Jiajie Tan, Santa Clara, CA (US); Xinming Zhou, Shanghai (CN); Junjie Cai, Palo Alto, CA (US); Jie Xu, Santa Clara, CA (US); Wangpeng An, San Mateo, CA (US); Zhiming Zou, Chicago, IL (US); Eric Ming-yen Lee, Chino Hills, CA (US)

(21) Appl. No.: 19/531,429

(22) Filed: Feb. 5, 2026

Related U.S. Application Data
(63) Continuation of application No. PCT/CN2026/076990, filed on Feb. 4, 2026.

(51) Int. Cl. G06T 17/05; G06T 19/00

(52) U.S. Cl. CPC G06T 17/05; G06T 19/00

(57) ABSTRACT

A system dynamically maps and updates item locations within a warehouse. A first set of sensors traverses the environment, capturing high-resolution spatial data the system uses to generate an item mapping for the warehouse. The item mapping maps items and structures to precise three-dimensional locations. A cart-mounted camera collects lower-granularity spatial data as it moves through the warehouse. The system identifies items in this new data, associates them with their positions, and compares the updated visual data to the item mapping. In response to detecting changes in item locations, the system updates the item mapping, enabling efficient, real-time tracking of inventory and layout changes with reduced computational resources.

### CROSS REFERENCE TO RELATED APPLICATIONS

This application is a bypass continuation of International Patent Application Serial No. PCT/CN 2026/076990, filed Feb. 4, 2026, which is incorporated by reference herein in its entirety.

### BACKGROUND

Traditionally, entities provide planograms and floorplans to document environment layouts, such as the arrangement of shelves and products in a warehouse. However, these documents are sometimes incomplete, outdated, or inaccurate, resulting in significant gaps and errors between the documented layout and the actual setup of the environment. Conventional planograms and floorplans also may be limited to two-dimensional representations and do not capture critical three-dimensional details, such as shelf heights and depths, which are necessary for precise product placement and reliable camera-based monitoring.

To supplement these static documents, entities may implement camera systems to detect and monitor items in the environment. While such systems can deliver real-time insights, they may rely on the assumption that the environment layout remains constant. In reality, environment layouts and arrangements may be frequently changed to accommodate new items, displays, or operational needs. These changes might not be captured promptly, causing camera systems and other automated tools to become out of sync with the actual environment. As a result, item detection becomes unreliable, and the underlying planogram and floor plan data become misaligned with the real-world state of the environment. Current approaches to updating these documents and systems often require significant manual intervention or resource-intensive data collection, limiting their scalability and timeliness.

### SUMMARY

Systems and methods for updating planograms and floorplans representative of warehouses (or other environments) are described herein. In particular, detailed spatial and visual data are captured by sensors as they traverse an environment to generate a baseline layout that maps items to specific locations within the environment. Additional item identifiers are incorporated to create a comprehensive three-dimensional (3D) map of item placements within the environment. Subsequently, less granular spatial data is collected using a cart-mounted camera. The 3D item-warehouse map is updated by associating new visual data with corresponding positions and comparing this new data to the original baseline. When changes in item locations are detected through this comparison, the baseline layout is automatically updated to reflect the current state of the environment. This approach enables dynamic and accurate maintenance of planograms and floorplans, even as items and layouts change over time.

The systems and methods described herein provide several technical benefits. First, they enable automated and efficient detection of changes in item locations without requiring manual intervention. Second, by using high-resolution spatial data to create an initial, detailed mapping of the environment and subsequently relying on lower-resolution data to update item locations within that mapping, the system significantly reduces the computational resources required for ongoing monitoring of the environment. Capturing and processing low-resolution data demands less bandwidth, storage, and processing power, making it feasible to collect and analyze this data more frequently. Thus, the system may achieve real-time or near real-time awareness of changes in the environment, ensuring that planograms and floorplans remain accurate and up-to-date with minimal resource consumption.

### BRIEF DESCRIPTION OF DRAWINGS

FIG. 1 illustrates an example environment of a smart cart system, in accordance with one or more illustrative embodiments.

FIG. 2A illustrates an example item-warehouse map at a first time, in accordance with one or more illustrative embodiments.

FIG. 2B illustrates an example item-warehouse map at a second time, in accordance with one or more illustrative embodiments.

FIG. 2C illustrates an example item-warehouse map at a third time, in accordance with one or more illustrative embodiments.

FIG. 3 is a flowchart of a method for altering a 3D item-warehouse map, in accordance with one or more illustrative embodiments.

### DETAILED DESCRIPTION

### Example System Environment for Smart Cart System

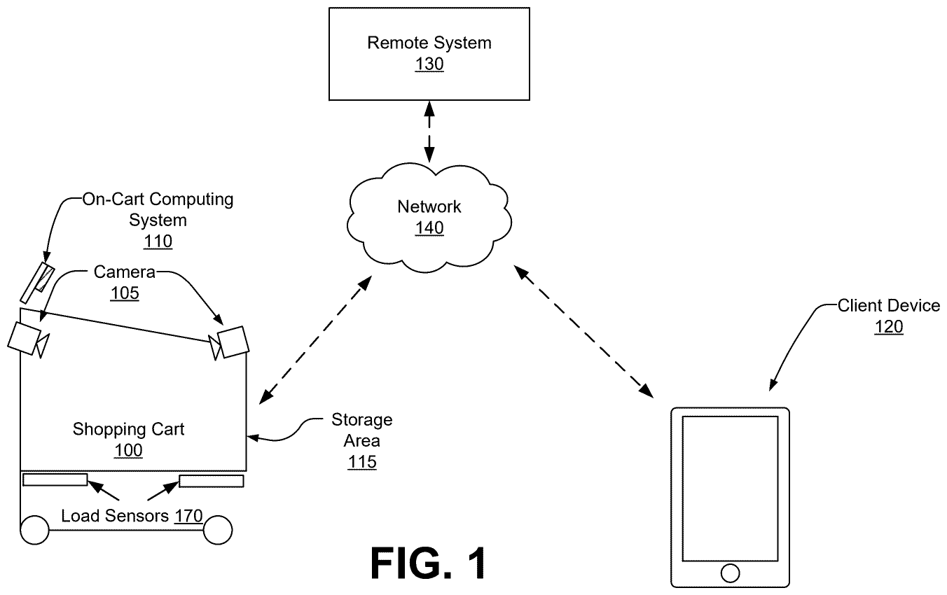

FIG. 1 illustrates an example system environment for a smart cart system, in accordance with one or more illustrative embodiments. The system environment illustrated in FIG. 1 includes a shopping cart 100, a client device 120, a remote system 130, and a network 140. Alternative embodiments may include more, fewer, or different components from those illustrated in FIG. 1, and the functionality of each component may be divided between the components differently from the description below. For example, functionality described below as being performed by the shopping cart may be performed, in some embodiments, by the remote system 130 or the client device 120. Similarly, functionality described below as being performed by the remote system 130 may, in some embodiments, be performed by the shopping cart 100 or the client device 120. Additionally, each component may perform their respective functionalities in response to a request from a human, or automatically without human intervention.

A shopping cart 100 is a vessel that a user can use to hold items as the user travels through a store. The shopping cart 100 includes one or more cameras 105 that capture image data of the shopping cart's storage area and a user interface that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors).

The cameras 105 capture image data of the shopping cart's storage area. The cameras 105 may capture two-dimensional or three-dimensional images of the shopping cart's contents. The cameras 105 are coupled to the shopping cart 100 such that the cameras 105 capture image data of the storage area from different perspectives. Thus, items in the shopping cart 100 are less likely to be overlapping in all camera perspectives. In some embodiments, the cameras 105 include embedded processing capabilities to process image data captured by the cameras 105. For example, the cameras 105 may be mobile industry processor interface (MIPI) cameras. The cameras 105 may be set to capture images from the area surrounding the shopping cart including the user of the cart. In some embodiments, at least one of the cameras 105 is directed outward, away from the shopping cart 100.

In some embodiments, the shopping cart 100 captures image data in response to detecting that an item is being added to the storage area. The shopping cart 100 may detect that an item is being added to the storage area 115 of the shopping cart 100 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 and store image data in response to detecting that an item is being added to the shopping cart 100 and for some period of time after that detection.

The shopping cart 100 may include one or more sensors that capture measurements describing the shopping cart 100, items in the shopping cart's storage area, or the area around the shopping cart 100. For example, the shopping cart 100 may include load sensors 170 that measure the weight of items placed in the shopping cart's storage area. Load sensors 170 are further described below. Similarly, the shopping cart 100 may include proximity sensors that capture measurements for detecting when an item is added to the shopping cart 100. The shopping cart 100 may transmit data from the one or more sensors to the remote system 130.

The one or more load sensors 170 capture load data for the shopping cart 100. In some embodiments, the one or more load sensors 170 may be scales that detect the weight (e.g., the load) of the content in the storage area 115 of the shopping cart 100. The load sensors 170 can also capture load curves (i.e., the load signal produced over time as an item is added to the cart or removed from the cart). The load sensors 170 may be attached to the shopping cart 100 in various locations to pick up different signals that may be related to items added at different positions of the storage area. For example, a shopping cart 100 may include a load sensor 170 at each of the four corners of the bottom of the storage area 115. In some embodiments, the load sensors 170 may record load data continuously while the shopping cart 100 is in use. In other embodiments, the shopping cart 100 may include some triggering mechanism, for example a light sensor, an accelerometer, or another sensor to determine that the user is about to add an item to the shopping cart 100 or about to remove an item from the shopping cart 100. The triggering mechanism causes the load sensors 170 to begin recording load data for some period of time, for example a preset time range.

The shopping cart 100 may include one or more wheel sensors (not shown) that measure wheel motion data of the one or more wheels. The wheel sensors may be coupled to one or more of the wheels on the shopping cart. In some embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In other embodiments, each of the wheels on the shopping cart has a wheel sensor (e.g., four wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0° when the shopping cart is moving straight and forward along an axis running through the front and the back of the shopping cart. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes an on-cart computing system 110 that enables the user to perform an automated checkout through the shopping cart 100. The computing system includes a processor and a non-transitory computer-readable medium that stores instructions that may be executed by the processor. The computing system 110 also may include a display, a speaker, a microphone, a keypad, or a payment system (e.g., a credit card reader). The computing system 110 also includes a wireless network adapter that allows the computing system to communicate via the network 140.

The on-cart computing system 110 allows a customer at a brick-and-mortar store to complete a checkout process in which items are scanned and paid for without having to go through a human cashier at a point-of-sale station. The on-cart computing system 110 receives data describing a user's shopping trip in a store and generates a shopping list based on items that the user has selected. For example, the on-cart computing system 110 may receive data from cameras or sensors coupled to the shopping cart 100 and may determine, based on the data, which items the user has added to their cart.

The on-cart computing system 110 may use machine-learning models or computer-vision techniques to identify items that the user adds to the shopping cart. For example, the on-cart computing system 110 may apply a barcode detection model to images captured by a camera of the shopping cart to identify items based on the barcodes that are visible to the camera. The barcode detection model is a machine-learning model (e.g., a neural network) that is trained to identify item identifiers that are encoded in barcodes that are depicted in image data. The barcode detection model may be trained based on a set of training examples. Each of the training examples may include an image of a barcode and a label that indicates what item identifier encoded by the barcode. In some embodiments, the on-cart computing system 110 preprocesses the image before applying the barcode detection model to the image. For example, the on-cart computing system may rotate the image so that the barcode is aligned with a set direction or may crop an image of an item to a portion of the image that depicts the barcode. U.S. patent application Ser. No. 17/703,076, entitled “Image-Based Barcode Decoding” and filed Mar. 24, 2022, describes an example barcode detection model in accordance with some embodiments and is incorporated by reference.

The on-cart computing system also may store and apply an optical character recognition (OCR) model to the image. An OCR model is a machine-learning model that converts typed, handwritten, or printed text depicted in images into machine-readable text. The on-cart computing system applies the OCR model to images captured by the cameras to identify items depicted in those images. For example, the on-cart computing system may generate a set of OCR text for an image. This OCR text is text that the OCR model has identified as being depicted in the image. The on-cart computing system uses the OCR text to identify items in images. For example, the on-cart computing system may apply another machine-learning model (e.g., a large language model) to the OCR text to predict which item is depicted in the image based on the OCR text.

In some embodiments, the on-cart computing system uses an item lookup table to identify items depicted in an image based on OCR text extracted from that image. The item lookup table stores a set of items that may be depicted in images captured by the cameras and corresponding text that is associated with each of the items. The on-cart computing system stores the item lookup table for use in identifying items. For example, the on-cart computing system may compare OCR text from an image to the corresponding text for each of the items to identify items depicted in images. The on-cart computing system may identify the item by identifying which item in the item lookup table has the most characters or words in common with the OCR text or which item has the longest sequence of characters in common with the OCR text. In some embodiments, rather than storing text in the item lookup table, the item lookup table stores embeddings that represent text associated with items. In these embodiments, the on-cart computing system may generate an embedding for OCR text and compare that embedding to the embeddings stored in the item lookup table to identify the item.

Furthermore, the on-cart computing system may store and apply an image embedding model to captured images to identify items. The image embedding model is a machine-learning model that is trained to generate embeddings for images captured by the cameras. The on-cart computing system applies the image embedding model to images captured by the cameras of the shopping cart and uses the embeddings to identify which items are depicted in the images. For example, the on-cart computing system may store embeddings that correspond to items that a user may place in the shopping cart. Each item may be associated with a single embedding or multiple embeddings. The on-cart computing system applies the image embedding model to images captured by the cameras and compares the generated embeddings to stored embeddings for items. The on-cart computing system identifies which item or items are depicted in an image based on how similar the generated embeddings are to the stored embeddings corresponding to the item(s). For example, the on-cart computing system may compute a distance, dot product, or cosine similarity between the embeddings to identify the item in the images. U.S. patent application Ser. No. 17/726,385, entitled “System for Item Recognition using Computer Vision” and filed Apr. 21, 2022, describes example methodologies for identifying items using a machine-learning model and is incorporated by reference.

Any of these models may be sensor fusion models that take sensor data as additional inputs. For example, a model may use weight data from a load sensor or proximity data from a proximity sensor as an additional input to predict an identifier for an item added to the shopping cart.

The on-cart computing system 110 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. When the user indicates that they are done shopping at the store, the on-cart computing system 110 interfaces with the remote system 130 to facilitate a transaction between the user and the store for the user to purchase their selected items. For example, the on-cart computing system 110 may receive payment information from the user through a user interface and transmit that payment information to the remote system 130.

The user interface of the on-cart computing system 110 may allow the user to adjust the items in their shopping list or to provide payment information for a checkout process. Additionally, the user interface may display a map of the store indicating where items are located within the store. In some embodiments, a user may interact with the user interface to search for items within the store, and the user interface may provide a real-time navigation interface for the user to travel from their current location to an item within the store. The user interface also may display additional content to a user, such as suggested recipes or items for purchase. In some embodiments, the on-cart computing system 110 may receive content from the remote system 130 to display to the user. For example, the on-cart computing system may receive item recommendations, recipe recommendations, or brand recommendations from the remote system 130.

The on-cart computing system may include a tracking system configured to track a position, an orientation, movement, or some combination thereof of the shopping cart 100 in an indoor environment. The tracking system may further include other sensors capable of capturing data useful for determining position, orientation, movement, or some combination thereof of the shopping cart. Other example sensors include, but are not limited to, an accelerometer, a gyroscope, etc. The tracking system may provide real-time location of the shopping cart to an online system and/or database. The location of the shopping cart may inform content to be displayed by the user interface. For example, if the shopping cart 100 is located in one aisle, the display can provide navigational instructions to a user to navigate them to a product in the aisle. In other example use cases, the display can provide suggested products or items located in the aisle based on the user's location.

A user can also interact with the shopping cart 100 or the remote system 130 through a client device 120. The client device 120 can be a personal or mobile computing device, such as a smartphone, a tablet, a laptop computer, or desktop computer. In some embodiments, the client device 120 executes a client application that uses an application programming interface (API) to communicate with the remote system 130 through the network 140. The client device 120 may allow the user to add items to a shopping list and to checkout through the remote system 130. For example, the user may use the client device 120 to capture image data of items that the user is selecting for purchase, and the client device 120 may provide the image data to the remote system 130 to identify the items that the user is selecting. The client device 120 may adjust the user's shopping list based on the identified item. In some embodiments, the user can also manually adjust their shopping list through the client device 120.

In some embodiments, the on-cart computing system 110, the camera(s), and the sensors of the shopping cart are separately mounted to the shopping cart. Alternatively, the on-cart computing system 110, camera(s), and sensors may be contained within a single casing that is mounted to the shopping cart. This single casing may contain all of the components needed by the on-cart computing system 110 to perform the functionalities described herein. The single casing may be permanently mounted to the shopping cart or may be configured to be easily attached to or detached from the shopping cart. This latter embodiment may enable the on-cart computing system 110 to be recharged at a separate station from the shopping cart or may allow the computing system 110 to be easily mounted to pre-existing shopping carts, rather than requiring specially built shopping carts.

The shopping cart 100 and client device 120 can communicate with the remote system 130 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In some embodiments, the network 140 may include Bluetooth or near-field communication (NFC) technologies or protocols for local communications between computing devices. The network 140 may transmit encrypted or unencrypted data.

The remote system 130 communicates with the on-cart computing system 110 of the shopping cart to provide an automated checkout experience for the user. The remote system 130 may facilitate the user's payment for the items in the shopping cart. For example, the remote system 130 may receive the user's shopping list from the shopping cart and may charge the user for the cost of the items in the cart. The remote system 130 may communicate with other systems to execute the transaction, such as a computing system of the retailer or of a financial institution. The remote system 130 may receive payment information from the shopping cart 100 and uses that payment information to charge the user for the items. Alternatively, the remote system 130 may store payment information for the user in user data describing characteristics of the user. The remote system 130 may use the stored payment information as default payment information for the user and charge the user for the cost of the items based on that stored payment information.

In some embodiments, the remote system 130 establishes a session for a user to associate the user's actions with the shopping cart 100 to that user. The user may establish the session by inputting a user identifier (e.g., phone number, email address, username, etc.) into a user interface of the remote system 130. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In some embodiments, the remote system 130 establishes a session between a user and a shopping cart 100 automatically based on sensor data from the shopping cart 100 or the client device 120. For example, the remote system 130 may determine that the client device 120 and the shopping cart 100 are in proximity to one another for an extended period of time, and thus may determine that the user associated with the client device 120 is using the shopping cart 100.

The remote system 130 may also provide content to the on-cart computing system 110 to display to the user while the user is operating the shopping cart. For example, the remote system 130 may use stored user data associated with the user of the shopping cart to select content that the user is most likely to interact with. The remote system 130 may transmit that content to the on-cart computing system for display to the user. The remote system 130 may also provide other data to the on-cart computing system. For example, the remote system 130 may store item data describing items in the store and the remote system 130 may provide that item data to the on-cart computing system for the on-cart computing system to use to identify items.

In some embodiments, a user who interacts with the shopping cart 100 or the client device 120 may be an individual shopping for themselves or a shopper for an online concierge system. The shopper is a user who collects items from a store on behalf of a user of the online concierge system. For example, a user may submit a list of items that they would like to purchase. The online concierge system may transmit that list to a shopping cart 100 or a client device 120 used by a shopper. The shopper may use the shopping cart 100 or the client device 120 to add items to the user's shopping list. When the shopper has gathered the items that the user has requested, the shopper may perform a checkout process through the shopping cart 100 or client device 120 to charge the user for the items. U.S. Pat. No. 11,195,222, entitled “Determining Recommended Items for a Shopping List,” issued Dec. 7, 2021, describes online concierge systems in more detail, which is incorporated by reference herein in its entirety.

The remote system 130 may cause one or more devices traversing an environment to capture spatial data. The environment may be an indoor environment, such as a warehouse, or an outdoor environment, such as a plant nursery. The sensors may be components of a simultaneous localization and mapping (SLAM) device, such as a mobile robot or handheld scanner. In some embodiments, the SLAM device is incorporated on a shopping cart 100. The sensors of the SLAM device may include LiDAR sensors, stereo or depth cameras, inertial measurement units (IMUs), and red-green-blue (RGB) or multispectral cameras. The LiDAR sensors emit laser pulses to measure distances to surrounding objects and surfaces, enabling precise three-dimensional mapping of the environment. Stereo or depth cameras capture visual and depth information, facilitating the identification and localization of items within the space. The IMUs provide acceleration and rotational data, helping to track the orientation and motion of the SLAM device as it traverses the environment. Together, these sensors collaboratively collect data representing position data of the SLAM device in the environment in relation to visual data of items in the environment. The position data and visual data may collectively be referred to as spatial data herein. In some embodiments, the spatial data may be captured from a set of SLAM devices traversing the environment. The remote system 130 receives spatial data from the SLAM device(s) as the SLAM device captures the spatial data, once the SLAM device has finished capturing the spatial data, or at intervals determined based on time or location of the SLAM device.

The remote system 130 uses the spatial data to generate a baseline layout of the environment. The baseline layout is a mapping of structures to locations within the environment. Examples of structures may include columns, shelves, tables, freezers, checkout stands, and the like. The remote system 130 may use algorithms or models to identify these structures in the visual data and map a three-dimensional version of each structure into the baseline layout at a corresponding position. For example, in some embodiments, the remote system 130 may determine, based on visual data, that a shelf spans from a first location to a second location. The remote system 130 may create a 3D rendering of the shelf and place the rendering between the first location and second location in the baseline layout.

The remote system 130 may update the baseline layout to create a 3D item-warehouse map (henceforth referred to as an item-warehouse map for simplicity) of the environment. The remote system 130 may apply object recognition algorithms or models to analyze the visual data, which may include images or depth maps captured by the SLAM device. The remote system 130 may identify individual items based on features like shape, size, color, or barcode information. In some embodiments, the remote system 130 applies one or more machine learning models or generative language models trained on items associated with the environment to identify such items in visual data. For each identified item, the remote system 130 may correlate an identifier of the respective item with corresponding position data and associate the identifier of the item in the baseline layout based on the corresponding position data. For example, the remote system 130 may determine that an item is at a third location. The remote system 130 may add the identifier of the item to the third location in the baseline layout. In some embodiments, the remote system 130 may add visual data of the item to the third location such that the item-warehouse mapping includes rendering of items at associated locations within the environment. The remote system 130 may also associate each identifier with a timestamp corresponding to the associated spatial data. The remote system 130 may store the resulting item-warehouse mapping locally or in a network-accessible location.

The remote system 130 may receive additional spatial data from one or more devices traversing the environment. The devices may each include a set of sensors, such a camera 105 or GPS. In some embodiments, one or more of the devices are shopping carts 100 with cameras 105 mounted to their frames. The additional spatial data may be of a lower granularity than the spatial data received from the SLAM device. For example, the spatial data may include periodic images or video frames, along with approximate position data derived from wheel encoders, inertial sensors, or GPS (in outdoor environments) on the respective device. In contrast, the spatial data captured from the SLAM device may be more granular and precise than that captured at a shopping cart 100 and include dense 3D mapping information and highly accurate position data in relation to both items and structures within the environment.

The remote system 130 may use this additional spatial data to monitor changes in the environment over time by comparing the new spatial data to the item-warehouse mapping. The remote system 130 may compare visual data associated with each location in the warehouse to the item-warehouse mapping. The location may be relative to a position of the device in the environment and may include a surrounding area that the remote system 130 assesses as part of the location. In some embodiments, rather than assess the visual data by location, the remote system 130 may first identify items in the additional spatial data before determining whether matching identifiers for the items are within the item-warehouse mapping. In some embodiments, the remote system adds identifiers of items determined from the additional spatial data to the item-warehouse mapping, along with a timestamp associated with the additional spatial data.

The remote system 130 detects discrepancies between the item-warehouse mapping determined based on the spatial data captured by the SLAM device and the additional spatial data. For instance, the remote system 130 may compare an item identifier of a first location to an item identifier determined for a subset of the additional spatial data that corresponds to the first location. In some embodiments, the remote system 130 compares visual data at each location in addition to or alternative to comparing identifiers. The remote system 130 may detect, based on the comparisons, whether changes in item location has occurred within the environment. Changes in item location may include an item no longer being located at a respective location or a new item being located at the respective location. In response to detecting, for a respective location, that a change in item location occurred, the remote system 130 may update the item-warehouse mapping to reflect the state of the respective location at the time the additional spatial data was captured. For example, the remote system 130 may determine that a first location is associated with a first item identifier at the timestamp of the additional spatial data but not in the item-warehouse mapping. The remote system 130 may update the item-warehouse mapping to indicate that the item is at the first location (e.g., by associating the item identifier or visual data of the item captured in the additional spatial data with the first location). In some embodiments, the remote system 130 may associate previously-stored visual data of the item with the first location, rather than visual data extracted from the additional spatial data.

The remote system 130 may continuously update the item-warehouse mapping based on additional spatial data received from one or more devices traversing the environment. Because the spatial data used to initially generate the item-warehouse mapping is more granular than the additional spatial data, the remote system 130 is able to leverage creating a detailed, accurate initial item-warehouse mapping for the environment while updating the item-warehouse mapping based on less granular data, which requires fewer computing resources to capture and transmit to the remote system 130 than the initially captured spatial data.

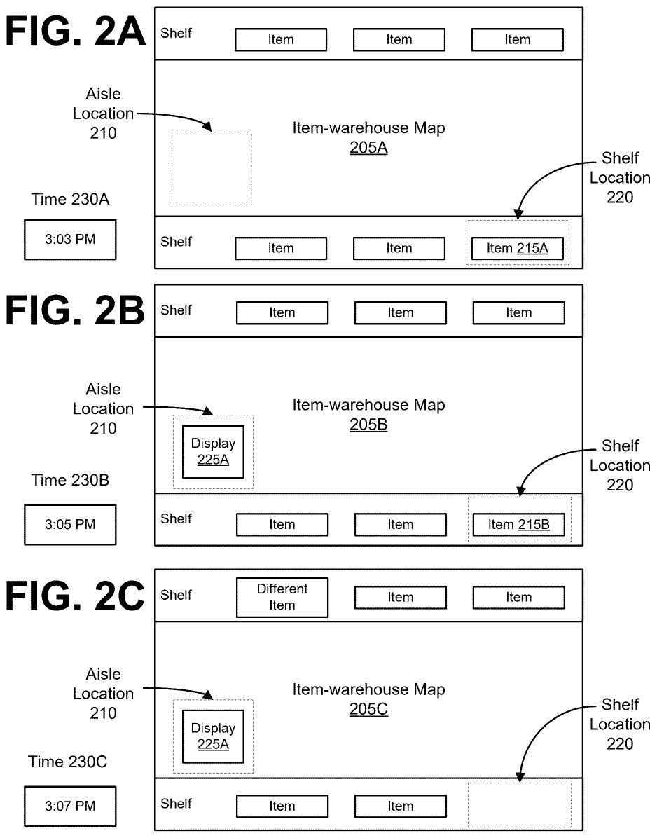

FIG. 2A illustrates an example item-warehouse map 205A at a first time 230A, in accordance with one or more illustrative embodiments. At the first time 230A, an aisle location 210 does not have an identifier of an item mapped to it in the item-warehouse map 205A and a shelf location 220 does have an identifier of an item 215A mapped to it. Though each location is shown as a rectangular area, in some embodiments, each location may be associated with an area of another geometric shape or may be associated with a range of sub-locations along one axis (e.g., right-to-left or front-to-back).

FIG. 2B illustrates the item-warehouse map 205B at a second time 230B, in accordance with one or more illustrative embodiments. The remote system 130 has updated the item-warehouse map 205A based on a first set of additional spatial data captured at the second time 230B. As shown in FIG. 2B, the remote system 130 determined that a display 225A was placed at the aisle location 210 between the first time 230A and the second time 230B and updated the item-warehouse map 205B to indicate that the display 225A is located at the aisle location. FIG. 2B also shows that the remote system 130 determined that a different item 215B was placed in the shelf location 220 and updated the item-warehouse map 205B to identify the new item 215B, rather than the previous item 215A, at the shelf location 220.

FIG. 2C illustrates the item-warehouse map 205C at a third time 230C, in accordance with one or more illustrative embodiments. Here, the remote system 130 has updated the item-warehouse map 205B based on a second set of additional spatial data captured at the third time 230C. The remote system 130 determined that the display 225A is still at the aisle location 210 (e.g., was not meaningfully moved between the second time 230B and the third time 225C) and thus did not need to update the identifier of the display 225A in the item-warehouse map 205C. However, the remote system 130 determined that no item is located at the shelf location 220 at the third time 230C and this removed the identifier of the previous item 215B from the item-warehouse mapping 205C.

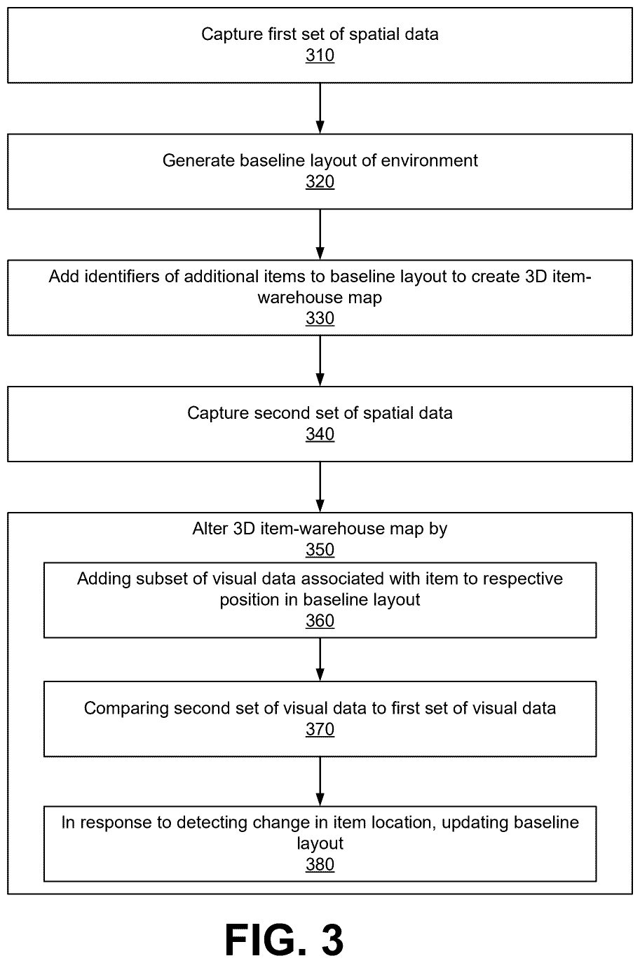

FIG. 3 is a flowchart of a method 300 for altering a 3D item-warehouse map, in accordance with one or more illustrative embodiments. In some embodiments, the method 300 includes additional or alternative steps to those shown in FIG. 3 or uses additional or alternative components described in relation to FIG. 3.

The method 300 begins with capturing, by a first set of sensors traversing a warehouse (or other environment), a first set of spatial data that includes a first set of position data of the first set of sensors and a first set of visual data of items in the warehouse. The remote system 130 generates a baseline layout of the warehouse using the first set of spatial data. The baseline layout may be a mapping of items or structures to locations within the warehouse. In some embodiments, the remote system 13 generates the baseline layout by applying Simultaneous Localization and Mapping (SLAM) to the first set of spatial data. The remote system 130 adds identifiers of one or more additional items positioned in the warehouse to the baseline layout to create a 3D item-warehouse map. For instance, the remote system 130 may use the first set of spatial data captured by the first set of sensors traversing the warehouse to determine identifiers for items mapped in the baseline layout and label corresponding locations within the baseline layout with the identifiers.

The remote system 130 captures a second set of spatial data from a cart-mounted camera 105 as an associated shopping cart 100 traverses the warehouse. The second set of spatial data may be less granular than the first set of spatial data. For example, the second set of spatial data may include data captured at longer time intervals than the first set of spatial data or may include less types of data (e.g., only image and position data) compared to the first set of spatial data, which may include one or more of high-resolution images, point cloud data, 3D camera pose trajectories, and camera intrinsics. In some embodiments, the shopping cart 100 with the camera 105 includes a WiFi module, such that second set of spatial data may include WiFi signal strength, which the remote system 130 may use to determine positions of the shopping cart 100 by comparing captured signal strength to a map of signal strength to position in the warehouse.

The remote system 130 alters the 3D item-mapping warehouse. In particular, the remote system 130 adds, for each item identified in the second set of spatial data, a subset of visual data (or identifier) associated with a respective position of the item at the respective position within the 3D item-warehouse mapping. The remote system 130 compares, for each position in both the first set of position data and the second set of position data, the second set of visual data to the first set of visual data. Put another way, the remote system 130 compares visual data of positions in the second set of spatial data to the same positions in the item-warehouse mapping. In response to detecting, at a respective position, a change in item location based on the comparison, the remote system 130 updates the 3D item-warehouse mapping based on the change in item location (e.g., a new item is there, an item is no longer there, etc.).

In some embodiments, rather than adding the visual data or identifier to the existing 3D item-warehouse mapping, the remote system 130 compares, for each location described in the second set of spatial data, the visual data or identifier determined for the second set of spatial data to the visual data or identifier associated with the location in the 3D item-warehouse mapping.

In some embodiments, each position in the second set of position data is determined by (1) detecting an anchor point within the second set of visual data, (2) accessing, from the 3D item-warehouse mapping, the position of the anchor point in the warehouse, and (3) computing the respective position based on the position of the anchor point in the warehouse.

In some embodiments, in response to receiving a third set of spatial data from sensors coupled to one or more additional shopping carts 100 in the warehouse, the remote system 130 alters the 3D item-warehouse mapping to include identifiers (or visual data) of items determined from the third set of spatial data. In some embodiments, the third set of spatial data includes a third set of position data and a third set of visual data. The remote system 130 compares, for each position in the third set of position data, subsets of visual data corresponding to the respective position from two or more of the first set of visual data, second set of visual data, and third set of visual data. In response to determining that a subset of the third set of visual data does not match one or more of the corresponding subsets of the second set of visual data and first set of visual data, the remote system 130 may send an alert to a client device 120 of an external operator, where the alert indicates the discrepancy in visual data (or, in some embodiments, identifiers).

### OTHER CONSIDERATIONS

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A method comprising:
capturing a first set of spatial data from a first set of sensors traversing an environment, the first set of spatial data including a first set of position data of the first set of sensors and a first set of visual data of items in a warehouse;
generating a baseline layout of the environment using the first set of spatial data, wherein the baseline layout comprises a mapping of items to locations within a warehouse;
adding identifiers of one or more additional items positioned in the warehouse to the baseline layout to create a three-dimensional (3D) item-warehouse map based on the first set of spatial data;
capturing a second set of spatial data from a cart-mounted camera, wherein the second set of spatial data is less granular than the first set of spatial data; and
altering the 3D item-warehouse map by:
adding, for each item identified in the second set of spatial data, a subset of visual data associated with a respective position at the respective position within the 3D item-warehouse map;
comparing, for each position in both the first set of position data and the second set of position data, the second set of visual data to the first set of visual data; and
in response to detecting, at a respective position, a change in item location based on the comparison, updating the 3D item-warehouse map based on the change in item location.

2. The method of claim 1, wherein each position in the second set of position data is determined by:
detecting an anchor point within the second set of visual data;
accessing, from the 3D item-warehouse map, the position of the anchor point in the environment; and
computing the respective position based on the position of the anchor point in the environment.

3. The method of claim 1, further comprising:
in response to receiving a third set of spatial data from sensors coupled to one or more additional shopping carts in the environment, altering the 3D item-warehouse map to include the third set of spatial data.

4. The method of claim 3, wherein the third set of spatial data includes a third set of position data and a third set of visual data, the method further comprising:
comparing, for each position in the third set of position data, subsets of visual data corresponding to the respective position from the first set of visual data, second set of visual data, and third set of visual data; and
in response to determining that the subset of the third set of visual data does not match one or more of the corresponding subsets of the second set of visual data and third set of visual data, sending an alert to a device of an external operator.

5. The method of claim 1, wherein generating the baseline layout of the environment comprises applying Simultaneous Localization and Mapping (SLAM) to the first set of spatial data.

6. The method of claim 1, wherein capturing the first set of spatial data includes capturing one or more of: high-resolution images, point cloud data, 3D camera pose trajectories, or camera intrinsics.

7. The method of claim 1, wherein the second set of sensors includes at least one camera and a Wi-Fi module.

8. A non-transitory computer-readable storage medium storing instructions that, when execute, cause a processor to perform steps comprising:
capturing a first set of spatial data from a first set of sensors traversing an environment, the first set of spatial data including a first set of position data of the first set of sensors and a first set of visual data of items in a warehouse;
generating a baseline layout of the environment using the first set of spatial data, wherein the baseline layout comprises a mapping of items to locations within a warehouse;
adding identifiers of one or more additional items positioned in the warehouse to the baseline layout to create a three-dimensional (3D) item-warehouse map based on the first set of spatial data;
capturing a second set of spatial data from a cart-mounted camera, wherein the second set of spatial data is less granular than the first set of spatial data; and
altering the 3D item-warehouse map by:
adding, for each item identified in the second set of spatial data, a subset of visual data associated with a respective position at the respective position within the 3D item-warehouse map;
comparing, for each position in both the first set of position data and the second set of position data, the second set of visual data to the first set of visual data; and
in response to detecting, at a respective position, a change in item location based on the comparison, updating the 3D item-warehouse map based on the change in item location.

9. The non-transitory computer-readable storage medium of claim 8, wherein each position in the second set of position data is determined by:
detecting an anchor point within the second set of visual data;
accessing, from the 3D item-warehouse map, the position of the anchor point in the environment; and
computing the respective position based on the position of the anchor point in the environment.

10. The non-transitory computer-readable storage medium of claim 8, the steps further comprising:
in response to receiving a third set of spatial data from sensors coupled to one or more additional shopping carts in the environment, altering the 3D item-warehouse map to include the third set of spatial data.

11. The non-transitory computer-readable storage medium of claim 10, wherein the third set of spatial data includes a third set of position data and a third set of visual data, the steps further comprising:
comparing, for each position in the third set of position data, subsets of visual data corresponding to the respective position from the first set of visual data, second set of visual data, and third set of visual data; and
in response to determining that the subset of the third set of visual data does not match one or more of the corresponding subsets of the second set of visual data and third set of visual data, sending an alert to a device of an external operator.

12. The non-transitory computer-readable storage medium of claim 8, wherein generating the baseline layout of the environment comprises applying Simultaneous Localization and Mapping (SLAM) to the first set of spatial data.

13. The non-transitory computer-readable storage medium of claim 8, wherein capturing the first set of spatial data includes capturing one or more of: high-resolution images, point cloud data, 3D camera pose trajectories, or camera intrinsics.

14. The non-transitory computer-readable storage medium of claim 8, wherein the second set of sensors includes at least one camera and a Wi-Fi module.

15. A system comprising:
a processor; and
a non-transitory computer-readable storage medium storing instructions that, when execute, cause the processor to perform steps comprising:
capturing a first set of spatial data from a first set of sensors traversing an environment, the first set of spatial data including a first set of position data of the first set of sensors and a first set of visual data of items in a warehouse;
generating a baseline layout of the environment using the first set of spatial data, wherein the baseline layout comprises a mapping of items to locations within a warehouse;
adding identifiers of one or more additional items positioned in the warehouse to the baseline layout to create a three-dimensional (3D) item-warehouse map based on the first set of spatial data;
capturing a second set of spatial data from a cart-mounted camera, wherein the second set of spatial data is less granular than the first set of spatial data; and
altering the 3D item-warehouse map by:
adding, for each item identified in the second set of spatial data, a subset of visual data associated with a respective position at the respective position within the 3D item-warehouse map;
comparing, for each position in both the first set of position data and the second set of position data, the second set of visual data to the first set of visual data; and
in response to detecting, at a respective position, a change in item location based on the comparison, updating the 3D item-warehouse map based on the change in item location.

16. The system of claim 15, wherein each position in the second set of position data is determined by:
detecting an anchor point within the second set of visual data;
accessing, from the 3D item-warehouse map, the position of the anchor point in the environment; and
computing the respective position based on the position of the anchor point in the environment.

17. The system of claim 15, the steps further comprising:
in response to receiving a third set of spatial data from sensors coupled to one or more additional shopping carts in the environment, altering the 3D item-warehouse map to include the third set of spatial data.

18. The system of claim 15, wherein generating the baseline layout of the environment comprises applying Simultaneous Localization and Mapping (SLAM) to the first set of spatial data.

19. The system of claim 15, wherein capturing the first set of spatial data includes capturing one or more of: high-resolution images, point cloud data, 3D camera pose trajectories, or camera intrinsics.

20. The system of claim 15, wherein the second set of sensors includes at least one camera and a Wi-Fi module.
